(19) United States
(12) Patent Application Publication
(10) Pub. No.: US 2024/0077104 A1
(43) Pub. Date: Mar. 7, 2024

(54) Crankshafts and Systems for Natural Gas Compression

(71) Applicant: ONBOARD DYNAMICS LLC, Bend, OR (US)

(72) Inventors: Shaun MAYEA, Bend, OR (US); Rick KAY, Troutdale, OR (US); Guy BABBITT, Fort Collins, CO (US); Christopher TURNER, Windsor, CO (US); Garrett CASASSA, Fort Collins, CO (US); Nicholas Paul ECHTER, Fort Collins, CO (US)

(21) Appl. No.: 18/457,502

(22) Filed: Aug. 29, 2023

Related U.S. Application Data
(60) Provisional application No. 63/402,307, filed on Aug. 30, 2022.

(51) Int. Cl. F16C 9/04; F02B 43/10; F02B 75/12; F02M 21/02; F16C 7/02

(52) U.S. Cl. CPC F16C 9/04; F02B 43/10; F02B 75/12; F02M 21/0209; F02M 21/0245; F16C 7/023; F02B 2043/103

(57) ABSTRACT

Modified connecting rod journals containing a first cylindrical portion and a second cylindrical portion can be used in a crankshaft of an internal combustion engine used in a gas compression system. These modified journals allow multiple stroke lengths for the pistons of the system thereby increasing system efficiency.

### CROSS REFERENCE TO RELATED APPLICATIONS

This application claims priority and the benefits under 35 U.S.C. § 119(e) to co-pending U.S. Provisional Application No. 63/402,307 filed on Aug. 30, 2022 and titled CRANKSHAFTS AND SYSTEMS FOR NATURAL GAS COMPRESSION, which is herein incorporated by reference in its entirety.

### BACKGROUND

Natural gas is an attractive fuel for vehicles due to its low cost and reduced emissions, including greenhouse gases. However, for effective use as a vehicle fuel, natural gas must be compressed to high pressure (typically around 4000 psi). Combined engine-compressors use automotive engines to package gas compression and the power required into the same machine. U.S. Pat. No. 5,400,751, incorporated by reference herein, provides further details regarding natural gas compressors.

When an internal combustion engine is modified for use as a natural gas compressor, the two parts of the engine—the combustion cylinders and the compression cylinders—share the same engine crankshaft. As a result, the combustion and compression pistons have the same piston speed at a given revolutions per minute (RPM).

V design engines, such as engine 10 shown in FIG. 1, have two connecting rods per connecting rod journal. Such engines can be used as natural gas compressors with stock crankshafts, in which case one of the connecting rods is connected to a combustion piston and the other is connected to a compression piston on either side of the engine 10. Crankshaft 20, shown in FIGS. 2-2A, is suitable for use with a V block engine and thus for the example shown (a V8 engine) the crankshaft has four connecting rod journals 22. Crankshaft 20 also includes main journals 24, counterweights 26, a flywheel mounting flange 28, and a crank nose 29 for pully and/or vibration mounting.

Referring to FIG. 2A, the crank radius x of the connecting rod journals 22 is the distance from the crankshaft centerline CLₑₛ to the center of the connecting rod journal centerline CLᵣⱼ. Because each of the connecting rod journals 22 has the same crank radius, the stroke (2 times x) is the same for each piston in the system. For example, if the crankshaft crank radius is 1.5 inches, the total stroke will be 3 inches. As a result, the mean piston speed at a given RPM is also the same for all cylinders.

### SUMMARY

In one aspect, the present disclosure features a gas compression system comprising: an internal combustion engine including (a) a compression cylinder and a compression piston disposed within the cylinder, and a combustion cylinder and a combustion piston disposed within the combustion cylinder; (b) a crankshaft comprising a connecting rod journal; (c) a first connecting rod connecting the connecting rod journal to the combustion piston, and (d) a second connecting rod connecting the connecting rod journal to the compression piston. The connecting rod journal is configured to have a combustion portion having a first crank radius, and a compression portion having a second crank radius smaller than the first crank radius, the first connecting rod being mounted on the combustion portion and the second connecting rod being mounted on the compression portion.

Some implementations include one or more of the following features. The combustion and compression portions may be non-concentric and have parallel axes of rotation. A point of the circumference of the first cylindrical portion may be contacting a point of the circumference of the second cylindrical portion. The internal combustion engine may be a V design engine, having any number of cylinders (e.g., V8 or higher). The connecting rod journal may be positioned between two counterweights. In some cases, the compression portion has a diameter, and the combustion portion has a diameter that is smaller than the diameter of the compression portion. The ratio between the diameter of the compression portion and the diameter of the combustion portion may be from 2:2.5 to 2:3.5. The internal combustion engine may include a plurality of additional compression cylinders and compression pistons disposed within the cylinders, and a plurality of additional combustion cylinder and combustion pistons disposed within the combustion cylinders. For example, the internal combustion engine may include at least 8 cylinders. The difference between the first crank radius and the second crank radius may be at least 0.25 inch, for example from about 0.25 to 1.0 inch.

In another aspect, the disclosure features a gas compression system comprising an internal combustion system having a plurality of compression cylinders and a plurality of combustion cylinders, a plurality of pistons disposed within the cylinders and operated by a common crankshaft; and a crankshaft configured such that at least one of the pistons will have a mean piston speed different from the other pistons.

Some implementations may include one or more of the following features. The crankshaft may include a connecting rod journal configured to have a combustion portion having a first crank radius, and a compression portion having a second crank radius smaller than the first crank radius, the first connecting rod being mounted on the combustion portion and the second connecting rod being mounted on the compression portion. The combustion and compression portions may be non-concentric and have parallel axes of rotation. A point of the circumference of the first cylindrical portion may be contacting a point of the circumference of the second cylindrical portion. The internal combustion engine may be a V design engine, e.g., a V8 or higher.

In yet another aspect, the disclosure features a method comprising providing a gas compression system comprising an internal combustion system having a plurality of compression cylinders and a plurality of combustion cylinders, a plurality of pistons disposed within the cylinders and operated by a common crankshaft; and configuring the crankshaft such that at least one of the pistons will have a mean piston speed different from the other pistons.

In some implementations, the crankshaft comprises a plurality of connecting rod journals to which the pistons are joined by connecting rods, and configuring the crankshaft comprises providing at least one connecting rod journal having a compression portion and a combustion portion, the two portions having different crank radii. The crankshaft may be configured such that the mean piston speed of at least one of the compression pistons is slower than a mean piston speed of the combustion pistons. In some cases, the internal combustion engine is a V design engine.

### DESCRIPTION OF THE DRAWINGS

FIG. 1 is a cross-sectional view of an internal combustion engine and a stock crankshaft.

FIG. 2 is a perspective view of a prior art stock crankshaft such as that used in the FIG. 1 system.

FIG. 2A is a front plan view of the stock crankshaft shown in FIG. 2.

FIG. 3 is a front plan view of a crankshaft with a single modified (destroked) connecting rod journal.

FIG. 3A is a perspective view of the crankshaft shown in FIG. 3.

FIG. 4 is a perspective view of a crankshaft in which all of the rod journals have been modified.

FIG. 4A is a cross-sectional view of the crankshaft shown in FIG. 4.

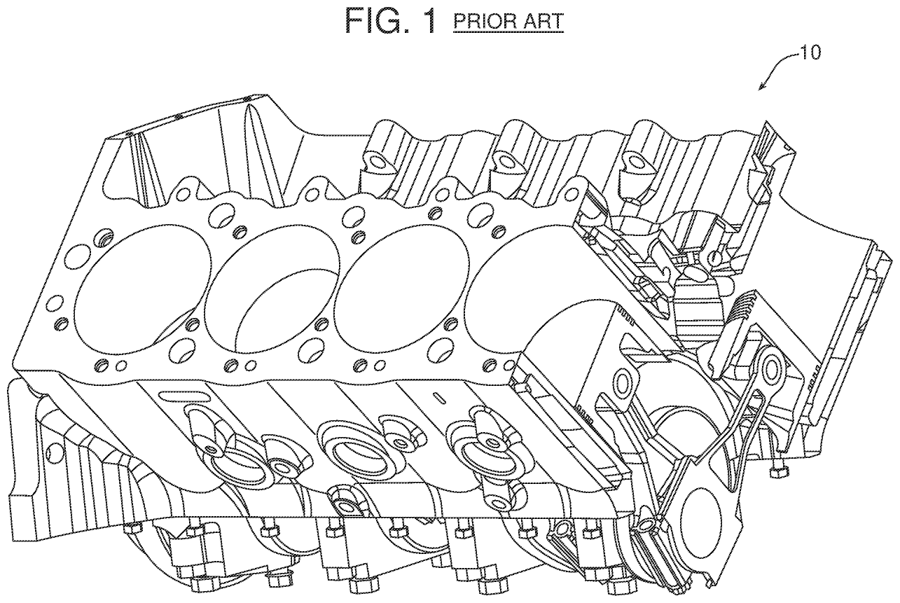

### DETAILED DESCRIPTION

The use of a conventional crankshaft in a natural gas compression system that utilizes an V design internal combustion engine can result in inefficiencies with the combustion and the compression systems. While it is desirable to run the engine at a high RPM, to produce more horsepower, the compression side has RPM limits because of friction and heat limitations. With a standard crankshaft, increasing the RPM at which the engine is run will result in a corresponding increase in mean piston speed which in turn results in increased friction and thus heat generated in the cylinder chamber. This heat can cause damage to seals, to the cylinder chamber and/or to the piston. For example, to minimize cylinder damage it is generally preferred that the mean piston speed on the compression side be less than about 18 feet/second, e.g., 15 feet/second or less, in some cases less than 12 feet/second or even less than 10 feet/second.

In the present disclosure, one or more connecting rod journals of the crankshaft are modified so that at least one of the pistons on the compression side has a reduced stroke length. As a result, in some implementations it is possible to run the engine at a higher RPM, e.g., greater than 2000 RPM or even greater than 2500 RPM, while maintaining the same piston speed in some or all of the compression cylinders, or, alternatively, to achieve lower piston speeds, e.g., less than 15 feet/second, in some or all of the compression cylinders without compromising RPM. Modifying the stroke length for individual cylinders on the compression side can allow the stroke length to be customized to achieve desired compression conditions in each cylinder, for example to improve compression during different stages of a multi-stage compression.

Modifying the connecting rod journal(s) can be accomplished in various manners, including starting with a conventional crankshaft and grinding down a portion of the rod journal, removing a rod journal of a conventional crankshaft and replacing it with a custom one, or providing a new crankshaft with connecting rod journals having a desired configuration. Another option is to add a lobe to a rod journal, e.g., by welding and machining or other suitable techniques, to increase the rod journal diameter.

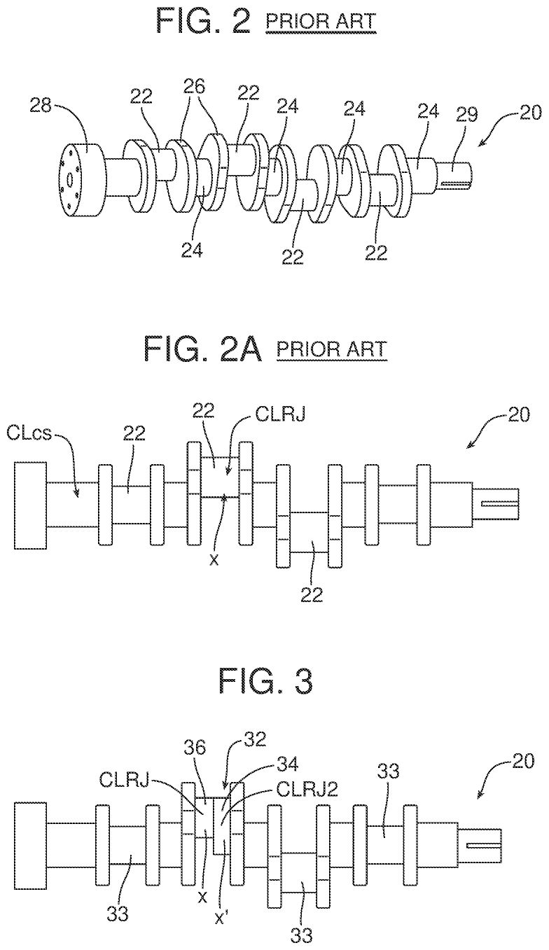

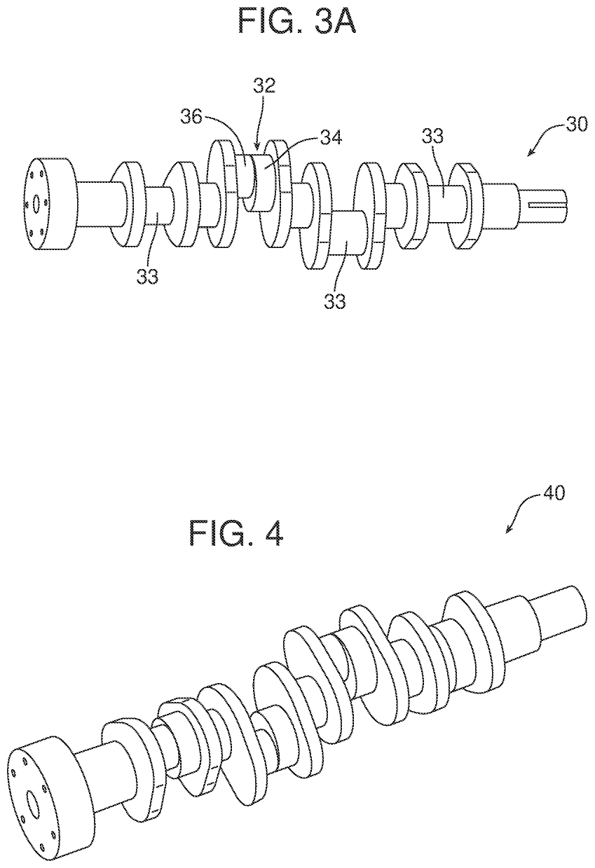

A modified crankshaft 30 is shown in FIGS. 3-3A. The modified crankshaft 30 includes a single modified connecting rod journal 32 and a plurality of stock connecting rod journals 33. Connecting rod journal 32 has a compression portion 34 to which a connecting rod on the compression side (not shown) is mounted, and a combustion portion 36, to which a connecting rod on the combustion side (not shown) is mounted. As shown in FIG. 3, the two portions are mounted on the crankshaft 30 so as to provide two different crank radii, and thus two different stroke lengths for the compression piston and combustion piston connected to this connecting rod journal. In this example, the combustion portion 36 of the connecting rod journal 32 provides the stock stroke length (the same stroke length provided by the crank radius x of connecting rod journals 22 in FIG. 2A) to the combustion piston, while the compression portion 34 has a shorter crank radius x 1 and thus provides the compression piston with a decreased stroke length, i.e., the modified portion of the journal results in “destroking” of the compression piston. This reduced stroke length causes the mean piston speed of the compression piston connected to compression portion 34 to be lower than the piston speed of the combustion piston connected to compression portion 36 at a given RPM. Thus, at a normal RPM, destroking will reducing friction and heat in the destroked cylinder during natural gas compression. Alternatively, the engine can be run at a higher RPM than is possible (without the potential for damage to one or more of the compression chambers) with a stock crankshaft due to the relatively lower mean piston speed of the destroked piston, giving the engine bank more horsepower.

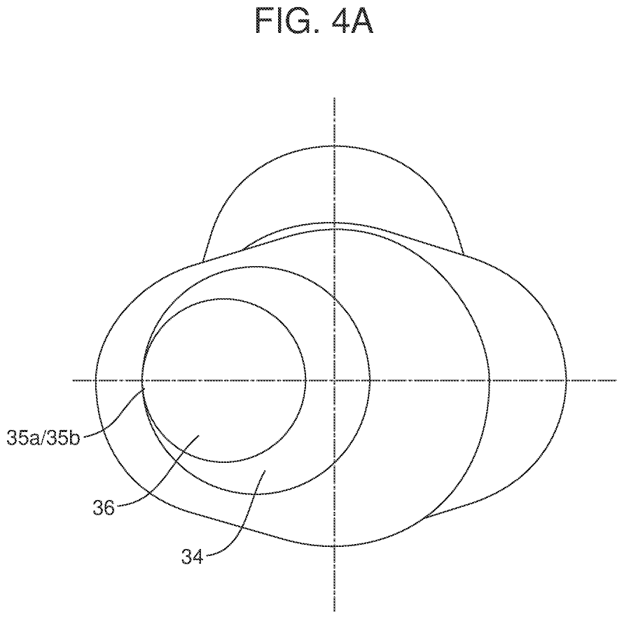

In the implementation shown in FIGS. 3-3A, the shorter crank radius results from the compression portion 34 having a larger diameter than the combustion portion 36, and the two journal portions being positioned so that they are flush at their edges 35a, 35b that are furthest from the centerline CLₑₛ of the crankshaft (FIG. 4A). Due to this positioning, the centerline CLᵣⱼ₂ of the modified compression portion 34 is offset from the centerline CLᵣⱼ of the combustion portion 36 as shown in FIG. 3. This offset of the centerlines results in the difference in crank radii and the corresponding reduction in stroke length of the piston connected to the modified compression portion 34. In this implementation, the cross-sections of the two portions 32 and 34 of the connecting rod journal are non-concentric and the two portions have parallel axes of rotation.

In some cases, it may be desirable to modify the stroke of only one of the connecting rod journals, for example if only a single cylinder is being damaged (e.g., experiencing seal damage or damage to the piston or cylinder chamber) by heat and friction. In this case, the connecting rod journal for that cylinder can be modified while keeping the rest of the rod journals stock. An example of such a configuration is the crankshaft shown in FIGS. 3-3A and discussed above.

Alternatively, it may be desirable to modify two or more of the rod journals, for example all of the rod journals, as shown in FIG. 4. In the crankshaft 40 shown in FIG. 4, all of the compression pistons associated with the connecting rod journals are “destroked” to the same extent, such that all of the compression pistons will have substantially the same mean piston speed (and the same reduction in piston speed compared to the combustion pistons) at a given RPM. However, as noted above, if desired the compression portions of the different connecting rod journals can have different crank radii from each other, so as to provide different piston speeds in different compression cylinders (e.g., for different stages of a multi-stage compression, or if only one cylinder is being damaged by heat/friction.)

As can be seen, for example, in FIG. 4A, the compression portion 34 has a diameter different from (in FIG. 4A, greater than) that of the combustion portion 36. It is noted that the diameter of combustion portion 36 may correspond to the diameter of a connecting rod journal in a stock crankshaft for a V design engine. The ratio of the diameter of the combustion portion to diameter of the compression portion can be, for example, from about 2:2.5 to 2:3.5. This ratio may be different for different compression stages.

The greater the ratio of the diameters of the portions, the greater the difference will be between the crank radii and thus the stroke lengths of the combustion side piston and the compression side piston. The difference between the two crank radii can be at least 0.25 inch, e.g., from about 0.25 to 1.0 inch. In some implementations, referring to FIG. 3 crank radius x can be from about 0.75 inch to 1.25 inch and crank radius x 1 can be from about 1.25 inch to 1.75 inch.

The connecting rod journals are usually positioned between two counterweights, as in the conventional crankshaft 20.

### EXAMPLES

### Example 1: Reduced Stroke to Decrease Mean Piston Speed at a Constant RPM

Mean piston speed has been calculated for two different crank radii, 1.5 inches and 1.05 inches (corresponding to the crank radii of portions 36 and 34, respectively, in FIG. 3), running the engine at 1800 RPM. The calculations and resulting mean piston speeds are shown in Table 1 below.

TABLE 1
Mean Piston Speed Combustion vs. Compression Cylinder at 1800 RPM

| | Calculations for Longer | | Calculations for Shorter | |
|---|---|---|---|---|
| | Crank Radius of the | | Crank Radius of the | |
| | Combustion Cylinder | | Compression Cylinder | |
| Crank Radius | 1.5 | inches | 1.05 | inches |
| Stroke (crank radius × 2) | 3 | inches | 2.1 | inches |
| Piston Distance/Revolution | 6 | inches/revolution | 4.2 | inches/revolution |
| (stroke × 2) | | | | |
| Mean piston speed (piston | 10800 | inches/minute | 7560 | inches/minute |
| distance/revolution × 1800 | | | | |
| RPM) | | | | |
| Mean piston speed in | 900 | feet/minute | 630 | feet/minute |
| feet/minute ((mean piston | | | | |
| speed in inches/minute)/12) | | | | |
| Mean piston speed in | 15 | feet/second | 10.5 | feet/second |
| feet/second ((mean piston | | | | |
| speed in feet/minute)/60) | | | | |

Thus, the relatively small difference in crank radii between the two portions of the connecting rod journal produces a significant decrease in mean piston speed on the compression side, minimizing the potential for damage in the compression cylinder due to heat and friction during compression.

### Example 2: Constant Mean Piston Speed (Compression Side) at Increased RPM

Mean piston speed has been calculated for two different crank radii, 1.5 inches and 1.05 inches (corresponding to the crank radii of portions 36 and 34, respectively, in FIG. 3), running the engine at a higher-than-normal 2571 RPM. The calculations and resulting mean piston speeds are shown in Table 2 below.

TABLE 2
Mean Piston Speeds at 2571 RPM

| | Calculations for Longer | | Calculations for Shorter | |
|---|---|---|---|---|
| | Crank Radius of the | | Crank Radius of the | |
| | Combustion Cylinder | | Compression Cylinder | |
| Crank Radius | 1.5 | inches | 1.05 | inches |
| Stroke (crank radius × 2) | 3 | inches | 2.1 | inches |
| Piston Distance/Revolution | 6 | inches/revolution | 4.2 | inches/revolution |
| (stroke × 2) | | | | |
| Mean piston speed (piston | 15426 | inches/minute | 10798.2 | inches/minute |
| distance/revolution × 2571 | | | | |
| RPM) | | | | |
| Mean piston speed in | 1285.5 | feet/minute | 899.85 | feet/minute |
| feet/minute ((mean piston | | | | |
| speed in inches/minute)/12) | | | | |
| Mean piston speed in | 21.425 | feet/second | 14.9975 | feet/second |
| feet/second ((mean piston | | | | |
| speed in feet/minute)/60) | | | | |

In this Example, the objective was to use 15 feet/second as a target mean piston speed for the compression cylinder, and utilize the destroking of the compression chamber to allow the engine to run at a higher RPM. Table 2 shows that due to its reduced stroke length the compression cylinder can run at the target mean piston speed while the combustion side runs at a higher-than-normal RPM (2571 RPM). This higher RPM on the combustion side gives the engine bank (i.e., combustion cylinders) more horsepower.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### OTHER EMBODIMENTS

The present invention is not to be limited in scope by the specific embodiments described herein. Indeed, various modifications of the invention in addition to those described herein will be apparent to those skilled in the art from the foregoing description. Such modifications are intended to fall within the scope of the appended claims.

What is claimed is:

1. A gas compression system comprising:
an internal combustion engine including
(a) a compression cylinder and a compression piston disposed within the cylinder, and a combustion cylinder and a combustion piston disposed within the combustion cylinder;
(b) a crankshaft comprising a connecting rod journal;
(c) a first connecting rod connecting the connecting rod journal to the combustion piston, and
(d) a second connecting rod connecting the connecting rod journal to the compression piston;
wherein the connecting rod journal is configured to have a combustion portion having a first crank radius, and a compression portion having a second crank radius smaller than the first crank radius, the first connecting rod being mounted on the combustion portion and the second connecting rod being mounted on the compression portion.

2. The gas compression system of claim 1, wherein the combustion and compression portions are non-concentric and have parallel axes of rotation.

3. The gas compression system of claim 1, wherein a point of the circumference of the first cylindrical portion is contacting a point of the circumference of the second cylindrical portion.

4. The gas compression system of claim 1, wherein the internal combustion engine is a V design engine.

5. The gas compression system of claim 1, wherein the connecting rod journal is positioned between two counterweights.

6. The gas compression system of claim 1, wherein the compression portion has a diameter, and the combustion portion has a diameter that is smaller than the diameter of the compression portion.

7. The gas compression system of claim 6 wherein the ratio between the diameter of the compression portion and the diameter of the combustion portion is from 2:2.5 to 2:3.5.

8. The gas compression system of claim 1, further comprising a plurality of additional compression cylinders and compression pistons disposed within the cylinders, and a plurality of additional combustion cylinder and combustion pistons disposed within the combustion cylinders.

9. The gas compression system of claim 4 wherein the internal combustion engine has at least 8 cylinders.

10. The gas compression system of claim 1 wherein the difference between the first crank radius and the second crank radius is at least 0.25 inch.

11. The gas compression system of claim 10 wherein the difference between the first crank radius and the second crank radius is from about 0.25 to 1.0 inch.

12. A gas compression system comprising:
an internal combustion system having a plurality of compression cylinders and a plurality of combustion cylinders, a plurality of pistons disposed within the cylinders and operated by a common crankshaft; and
a crankshaft configured such that at least one of the pistons will have a mean piston speed different from the other pistons.

13. The gas compression system of claim 12 wherein the crankshaft comprises a connecting rod journal configured to have a combustion portion having a first crank radius, and a compression portion having a second crank radius smaller than the first crank radius, the first connecting rod being mounted on the combustion portion and the second connecting rod being mounted on the compression portion.

14. The gas compression system of claim 12, wherein the combustion and compression portions are non-concentric and have parallel axes of rotation.

15. The gas compression system of claim 12, wherein a point of the circumference of the first cylindrical portion is contacting a point of the circumference of the second cylindrical portion.

16. The gas compression system of claim 12, wherein the internal combustion engine is a V design engine.

17. A method comprising:
providing a gas compression system comprising an internal combustion system having a plurality of compression cylinders and a plurality of combustion cylinders, a plurality of pistons disposed within the cylinders and operated by a common crankshaft; and
configuring the crankshaft such that at least one of the pistons will have a mean piston speed different from the other pistons.

18. The method of claim 17, wherein the crankshaft comprises a plurality of connecting rod journals to which the pistons are joined by connecting rods, and configuring the crankshaft comprises providing at least one connecting rod journal having a compression portion and a combustion portion, the two portions having different crank radii.

19. The method of claim 17, wherein the crankshaft is configured such that the mean piston speed of at least one of the compression pistons is slower than a mean piston speed of the combustion pistons.

20. The method of claim 17, wherein the internal combustion engine is a V design engine.
